(19) United States
(12) Patent Application Publication
(10) Pub. No.: US 2025/0182200 A1
(43) Pub. Date: Jun. 5, 2025

(54) METHOD AND SYSTEM FOR BORROWER IDENTIFICATION

(71) Applicant: Lendingkart Technologies Private Limited, Ahmedabad (IN)

(72) Inventors: Harshvardhan Lunia, GJ (IN); Vibhor Kalra, Bengaluru (IN); Giridhar Yasa, Bangalore (IN); Manish Bhatia, Hyderabad (IN); Nitin Shiralkar, Hyderabad (IN); Prasanna Kumar, Bangalore (IN); Amit Abhishek, Bangalore (IN); Aditya Veluri, Bangalore (IN)

(21) Appl. No.: 18/747,786

(22) Filed: Jun. 19, 2024

(30) Foreign Application Priority Data
Dec. 4, 2023 (IN) 202321082515

(51) Int. Cl. G06Q 40/03

(52) U.S. Cl. CPC G06Q 40/03

(57) ABSTRACT

Methods and systems for a borrower identification and prediction of credit risk associated with the identified borrower is provided. The system includes a server that retrieves an electronic message that includes details of transactions conducted by a first entity over a time. The electronic message is parsed based on a predefined parameter, to identify a second entity, where the first entity has conducted a business transaction with the second entity. Further, a first set of details associated with the second entity is obtained from one or more resources associated with the server. Furthermore, a knowledge graph is generated based on the business transaction and the first set of details. The knowledge graph indicates an association between the first entity and the second entity. Subsequently, a credit risk score associated with lending money to the second entity is predicted based on the knowledge graph.

### FIELD

Various embodiments of the disclosure relate generally to data analytics of SMEs (small and medium-sized enterprise). More specifically, various embodiments of the disclosure relate to a method and system for borrower identification.

### BACKGROUND

Traditionally, loan lending companies use data-driven techniques to identify a potential loan candidate prior to approaching the candidate to offer a loan. In the technique, the loan lending companies track the candidate's online activities such as browsing history, search queries, and interactions with financial content. The tracking includes following the browsing history to identify loan-related terms and/or detecting visits of the candidate to loan offering websites to spot an interest of the candidate in obtaining the loan. The tracking may further include assessing social media posts and interactions of the candidates to identify the interest of the candidate in obtaining the loan. However, the traditional methods of identifying the potential loan candidates is a tedious task, time consuming, and requires bulk of data to be analyzed.

In light of the foregoing, there exists a need for a technical and reliable solution that overcomes the abovementioned problems and ensures efficient method and system for identifying a potential candidate with a loan requirement.

Limitations and disadvantages of conventional and traditional approaches will become apparent to one of skill in the art, through comparison of described systems with some aspects of the present disclosure, as set forth in the remainder of the present application and with reference to the drawings.

### SUMMARY

Methods and systems for a borrower identification and prediction of credit risk associated with the identified borrower is provided substantially as shown in, and described in connection with, at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

FIG. 1 is a block diagram that illustrates a system environment for borrower identification, in accordance with an exemplary embodiment of the present disclosure;

FIG. 2 is a block diagram that illustrates processing circuitry and a memory associated with the borrower identification, in accordance with an exemplary embodiment of the present disclosure;

FIG. 3 is an example of knowledge map, in accordance with an embodiment of the present disclosure;

FIG. 4 represents a flowchart that illustrates a method for a borrower identification and prediction of credit risk associated with the identified borrower, in accordance with an embodiment of the present disclosure; and

FIG. 5 is a block diagram that illustrates a system architecture of a computer system for borrower identification, in accordance with an exemplary embodiment of the disclosure.

### DETAILED DESCRIPTION

As used in the specification and claims, the singular forms “a”, “an” and “the” include plural references unless the context clearly dictates otherwise. For example, the term “an article” may include a plurality of articles unless the context clearly dictates otherwise.

Those with ordinary skill in the art will appreciate that the elements in the figures are illustrated for simplicity and clarity and are not necessarily drawn to scale. For example, the dimensions of some of the elements in the figures may be exaggerated, relative to other elements, in order to improve the understanding of the present invention. There may be additional components described in the foregoing application that are not depicted on one of the described drawings. In the event such a component is described, but not depicted in a drawing, the absence of such a drawing should not be considered as an omission of such design from the specification.

Before describing the present invention in detail, it should be observed that the present invention constitutes a method and system for predicting an entity that needs a loan. Accordingly, the components have been represented, showing only specific details that are pertinent for an understanding of the present invention so as not to obscure the disclosure with details that will be readily apparent to those with ordinary skill in the art having the benefit of the description herein.

As required, detailed embodiments of the present invention are disclosed herein; however, it is to be understood that the disclosed embodiments are merely exemplary embodiments of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

References to “one embodiment”, “an embodiment”, “another embodiment”, “yet another embodiment”, “one example”, “an example”, “another example”, “yet another example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

While typical embodiments have been set forth for the purpose of illustration, the foregoing description should not be deemed to be a limitation on the scope of the disclosure or appended claims. Accordingly, various modifications, adaptations, and alternatives may occur to one skilled in the art without departing from the scope of the present disclosure.

Certain embodiments of the disclosure may be found in disclosed system and method for borrower identification. In an embodiment, a method is disclosed. The method comprises receiving an electronic message that includes details of a plurality of business transactions conducted by an enterprise over a time. The method further comprises parsing the electronic message based on a predefined parameter, to identify a second entity. the first entity has conducted a business transaction, of the plurality of transactions, with the second entity. The server obtains a first set of details associated with the second entity from one or more resources associated with the server. Further, the method comprises generating a knowledge graph based on the business transaction and the first set of details. the knowledge graph indicates an association between the first entity and the second entity. Further, the method includes predicting a credit risk score associated with lending money to the second entity based on the knowledge graph.

In some embodiments, the method further comprises acquiring a second set of details associated with the second entity from the one or more resources.

In some embodiments, the second set of details corresponds to public information associated with the second entity.

In some embodiments, the first set of details corresponds to personal information associated with the second entity. The personal information includes financial record of the second entity.

In some embodiments, the one or more resources includes an internal resource maintained by a lender or an external resource available on internet.

In some embodiments, the method further comprises recommending a loan scheme to the second entity in an event the predicted credit risk score is below a predefined threshold.

In some embodiments, the method further comprises receiving a new electronic message and updating the knowledge graph with a new business entity included in the new electronic message.

In some embodiments, the second entity is a potential individual seeking a loan.

In some embodiments, the electronic message is received in a format such as pdfs, word, or excel.

In some embodiments, parsing the electronic message includes breaking the electronic message into small elements to identify one or more business entities involved in one or more of the plurality of transactions.

In some embodiments, the predefined parameter includes name of one or more business entities included in the electronic message.

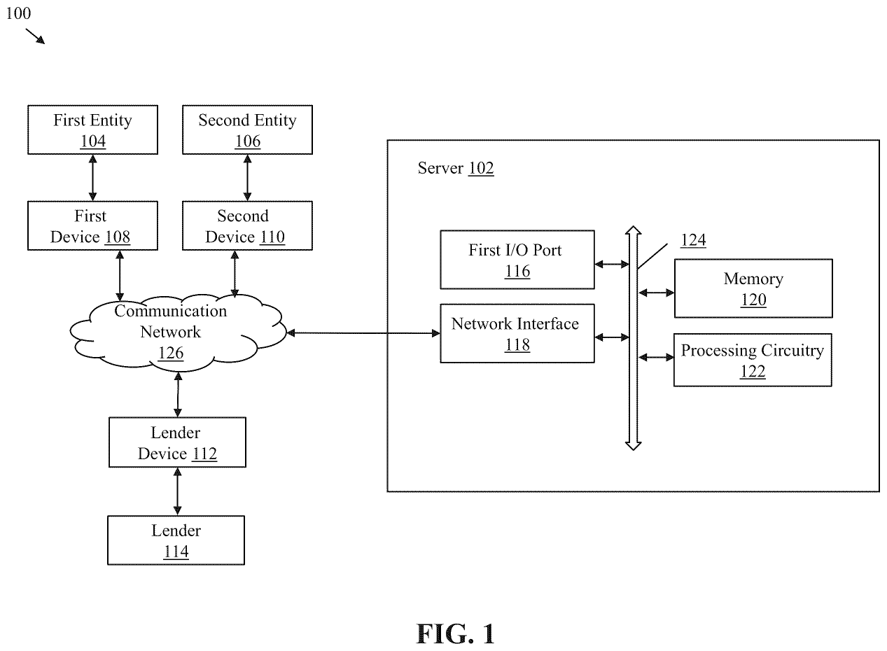

FIG. 1 is a block diagram that illustrates a system environment 100 for borrower identification, in accordance with an exemplary embodiment of the present disclosure. The system environment 100 is shown to include a server 102, a first entity 104, a second entity 106, a first device 108, a second device 110, a lender device 112, and a lender 114. The server 102, the first device 108, the second device 110, and the lender device 112 are communicatively coupled to each other via a communication network 126.

The server 102 may be configured to perform various functions such as identifying a borrower, predicting credit risk associated with offering a loan to the borrower, and/or the like. The borrower may be an individual or an entity engaged in a financial arrangement with the lender 114. The borrower may request for a loan from the lender 114. The loan is a sum of money borrowed by the borrower from the lender 114 in exchange of repayment of the borrowed sum of money along with an interest. The loan may be requested with a purpose, such as, a home improvement, travel, educational expenses, business development and the like as may be understood by those skilled in the art. The loan may be requested by submitting an application to the lender 114. The application may include details such as the sum of money to be borrowed, associated interest rate, intended duration for loan repayment, and the like.

The server 102 may be a network of computers, a software framework, or a combination thereof, that may provide a generalized approach to create a server implementation. Examples of the server 102 may include, but are not limited to, personal computers, laptops, mini-computers, mainframe computers, any non-transient and tangible machines that can execute a machine-readable code, cloud-based servers, distributed server networks, or a network of computer systems. The server 102 may be realized through various web-based technologies such as, but not limited to, a Java web-framework, a .NET framework, a personal home page (PHP) framework, or any web-application framework. The server 102 may be maintained by the lender 114 that facilitates lending the loan or a credit to the borrower. The server 102 may include a first input/output (I/O) port 116, a network interface 118, memory 120, and processing circuitry 122 communicatively coupled to each other via a communication bus 124.

The first I/O port 116 includes suitable logic, circuitry, and/or interfaces that are operable to execute one or more instructions stored in the memory 120 to perform one or more operations. The I/O first port 116 may include various input and output devices that are configured to operate under the control of the processing circuitry 122 by way of the communication bus 124. For example, via the I/O first port 116, an administrator associated with the server 102 provides one or more inputs to perform one or more operations. Examples of the input device may include a universal serial bus (USB) port, an Ethernet port, a real or virtual keyboard, a mouse, a joystick, a touch screen, a stylus, a microphone, and the like. Examples of the output device may include a display screen, a speaker, headphones, a universal serial bus (USB) port, an Ethernet port, and the like.

The network interface 118 may include suitable logic, circuitry, interfaces, and/or code, executable by the circuitry, for facilitating communication using one or more communication protocols. The network interface 118 may be communicatively coupled to the first device 108, second device 110, and the lender device 112 via the communication network 126. Examples of the network interface 118 may include, but are not limited to, an antenna, a radio frequency transceiver, a wireless transceiver, a Bluetooth transceiver, an ethernet-based transceiver, a universal serial bus (USB) transceiver, an NFC-based transceiver, or any other device configured to transmit and receive data.

The memory 120 may include suitable logic, circuitry, and interfaces that may be configured to store an electronic message received via the first I/O port 116. The electronic message may include profile and financial record of the borrower submitted during the application of the loan by the borrower. In an example, the electronic message may include profile and financial record of the first entity 104 submitted during application of a loan by the first entity 104. In another example, the electronic message may include a profile and financial record of the second entity 106 submitted during application of a loan by the second entity 106. The profile of the first entity 104 and the profile of second entity 106 may include name, age, gender, educational qualifications, employment details, salary, travel history, social media history, and the like of the first entity 104 and the second entity 106, respectively. The financial record of the first entity 104 and the financial record of the second entity 106 may include bank statement, income tax return details, and the like of the first entity 104 and the second entity 106, respectively. The financial record of the first entity 104 and the financial record of the second entity 106 may further include credit bureau data of the first entity 104 and the second entity 106, respectively. The credit bureau data may include credit information such as credit account details, payment history, balance of the credit account, credit limit, and the like.

The profile and financial record of the first entity 104 and the profile and financial record of the second entity 106 stored in the memory 120 may be referred to as historical data record. In an embodiment, the memory 120 may be updated with new electronic messages received in real-time. In an example, the new electronic messages may include a profile and financial record of a new entity that has submitted an application for loan.

Examples of the memory 120 may include, but are not limited to, a random-access memory (RAM), a read-only memory (ROM), a removable storage drive, a hard disk drive (HDD), a flash memory, a solid-state memory, or the like. It will be apparent to a person skilled in the art that the scope of the disclosure is not limited to realizing the memory 120 in the server 102, as described herein. In other embodiments, the memory 120 may be realized in the form of a database or a cloud storage working in conjunction with the processing circuitry 122, without deviating from the scope of the disclosure.

The processing circuitry 122 may include suitable logic, circuitry, interfaces, and/or code, executable by the circuitry, that may be configured to perform functions of borrower identification and prediction of a credit risk associated with lending money to the identified borrower. The processing circuitry 122 may be configured to retrieve the electronic message from the memory 120. The electronic message may include the profile and the financial record of one of the first entity 104 and the second entity 106. The bank statement of the first entity 104 includes name, address, and account number of the first entity 104, and details of a plurality of transactions conducted by the first entity 104 over a time, defined in a table. A first column of the table may include a date corresponding to a transaction, of the plurality of transactions, that indicates the date on which the transaction was performed. Further, a second column of the table may include a name of individual with whom the first entity 104 has conducted the transaction. Furthermore, a third column and a fourth column of the table may include description of transaction, and debit amount or credit amount associated with the transaction, respectively. Each row of the table may include plurality of transactions. The bank statement of the second entity 106 includes similar details as described with respect to the bank account statement of the first entity 104.

The processing circuitry 122 is further configured to parse the retrieved electronic message based on a plurality of predefined parameters, to identify the borrower. The plurality of predefined parameters includes a type of business entity mentioned in the name of the business entity, the amount of the transaction, credit worthiness of the business entity, historical data of the business entity, residential address, business address, and business registration proof. In an example, the bank account statement of the first entity 104 is parsed to identify the individual with whom the first entity 104 has conducted a business transaction. The business transaction maybe an exchange of money between two or more entities for conducting a business. In an embodiment, the identified individual is a business entity. In an example, the identified individual or the business entity is the second entity 106.

The processing circuitry 122 is furthermore configured to obtain a first set of details associated with the second entity 106 from the memory 120. The first set of details corresponds to personal information associated with the second entity 106. The personal information may include financial record of the second entity. Further, the processing circuitry 122 may be configured to generate a knowledge map based on the plurality of transactions and the obtained set of details. Thus, the knowledge map indicates an association or relation between the first entity 104 and the second entity 106.

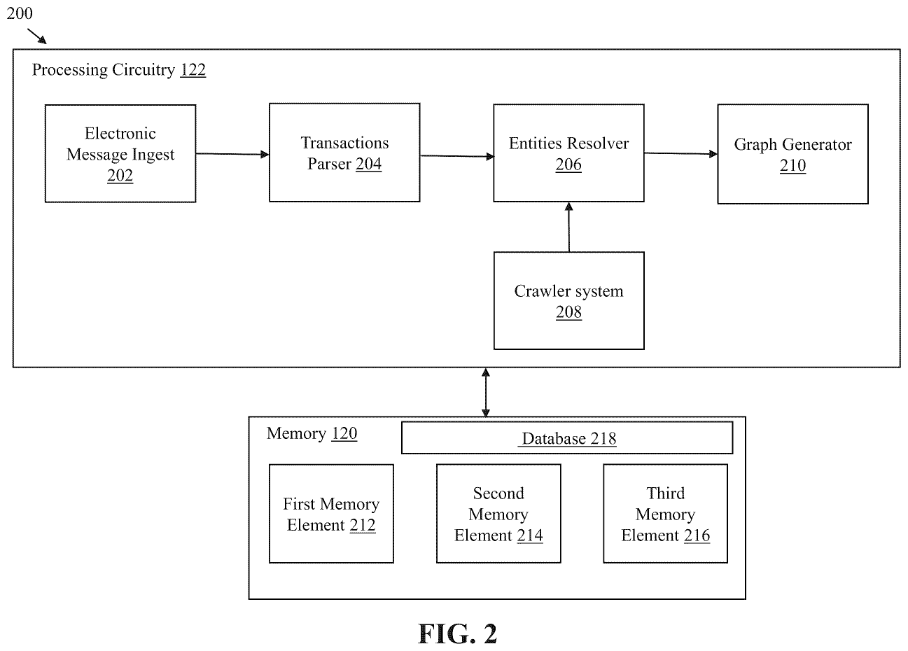

The processing circuitry 122 is further configured to acquire second set of details corresponding to the second entity 106 from one or more resources. The second set of details of the second entity 106 is obtained using a crawler system (shown in FIG. 2) of the processing circuitry 122, which employs an Artificial Intelligence (AI)-driven profile crawler to identify various data sources, such as Google®, Indiamart®, or the company's website to obtain the additional details. The crawler system is described in detail in conjunction with FIG. 2.

The processing circuitry 122 may be configured to predict a credit risk score associated with lending money to the second entity 106 based on the knowledge map and the additional details. Further, the processing circuitry 122 compares the generated credit risk score with a predefined threshold value to identify if it would be safe to issue a loan to the second entity 106. In an embodiment, the predefined threshold value is set by the lender 114.

Examples of the processing circuitry 122 may include, but are not limited to, an application-specific integrated circuit (ASIC) processor, a reduced instruction set computing (RISC) processor, a complex instruction set computing (CISC) processor, and a field-programmable gate array (FPGA). It will be apparent to a person of ordinary skill in the art that the circuitry 122 may be compatible with multiple operating systems. The processing circuitry 122 is further described in detail in conjunction with FIG. 2.

The first entity 104 is an entity that has submitted a first application for the loan with the lender 114 via the first device 108. The second entity 106 is an entity that has submitted an application for the loan with the lender 114 via the second device 110. The application for the loan of the second entity 110 may or may not have been processed by the lender 114. In an example, the first entity 104 or the second entity 106 is a business entity engaged in a trade. The first device 108 and the second device 110 may be utilized by the first entity 104 and the second entity 106, respectively, to raise a loan request, select one of the pluralities of offers offered by the lender 114. The plurality of offers may include an amount committed to be lent for a specified time duration via the lender device 112, interest rate for disbursing the loan, loan repayment duration, or the like. Examples of the first device 108 and the second device 110 may include a smartphone, a tablet, a phablet, a personal digital assistant, a laptop, a computer, or the like.

The lender device 112 is an electronic device utilized by the lender 114 for performing various functions associated with borrower identification. The lender device 112 may be utilized by the lender 114 to perform various functions associated with borrower identification by utilizing a service application installed on the lender device 112. In a non-limiting example, the lender 114 may provide an amount committed to be lent for a specified time duration via the lender device 112 to the borrower. Examples of the lender device 112 may include, but are not limited to a smartphone, a tablet, a phablet, a personal digital assistant, a laptop, a computer, or the like. In an embodiment, the lender device 112, the first device 108, and the second device 110 may be geographically remote from the server 102.

The communication network 126 may include, but is not limited to, a wireless fidelity (Wi-Fi) network, a light fidelity (Li-Fi) network, a wide area network (WAN), a metropolitan area network (MAN), the Internet, an infrared (IR) network, a radio frequency (RF) network, a near field communication (NFC) network, a Bluetooth network, a Zigbee network, and a combination thereof. Various entities (such as the server 102, the first device 108, the second device 110, and the lender device 112) in the system environment 100 may be coupled to the communication network 126 in accordance with various wired and wireless communication protocols, such as Transmission Control Protocol and Internet Protocol (TCP/IP), Enterprise Datagram Protocol (UDP), Long Term Evolution (LTE) communication protocols, an IEEE 802.11 standard protocol, an IEEE 802.15 standard protocol, an IEEE 802.15.4 standard protocol, or any combination thereof.

FIG. 2 is a block diagram 200 that illustrates processing circuitry 122 and a memory 120 associated with the system and method for a borrower identification, in accordance with an exemplary embodiment of the present disclosure. The processing circuitry 122 may include an electronic message ingest 202, a transaction parser 204, an entities resolver 206, a crawler system 208, and a graph generator 210. The memory 120 may include a first memory element 212, a second memory element 214, a third memory element 216, and a database 218.

In operation, the electronic message ingest 202 is configured to retrieve one or more electronic messages of the first entity 104 or the second entity 106 from the memory 120 based on a defined criteria. In particular, the one or more electronic messages are stored in the database 218 of memory 120. In an embodiment, the one or more retrieved electronic message may be associated with the historical data record. In another embodiment, an electronic message, from the one or more electronic messages, retrieved from the database 218 may be associated with a new electronic message that includes details of a plurality of transactions conducted by a new entity over a time. The electronic message may be retrieved in any of file formats such as (Portable Document Format) pdfs, word, or excel. The defined criteria is a criteria defined by the lender 114 and may include, for example, date of sourcing the electronic message to the memory 120, a date mentioned in the financial records of the electronic message, number of transactions recorded in the electronic message, or the like. In an example, the defined criteria is to select the electronic message that includes more than 70 transactions. In such a scenario, if the retrieved electronic message is the bank statement of the first entity 104 that includes less than 50 transactions and another bank statement of the second entity 106 with more than 100 transactions, the electronic message ingest 202 may be configured to select the bank statement of the second entity 106 based on the defined criteria. In another example, the electronic message ingest 202 may retrieve the new electronic message from the database 218 based on the defined criteria. The one or more retrieved electronic messages are fed into the transaction parser 204 by the electronic message ingest 202. For the sake of brevity, the one or more electronic messages and electronic message has been used interchangeably throughout the description.

The transaction parser 204 is a complier configured to break the one or more retrieved electronic messages into small elements to identify a target entity or a potential borrower. In particular, the transaction parser 204 is configured to parse the electronic message and categorize the parsed messages. In an embodiment, the financial record of the first entity 104 (such as such as bank statement of the first entity 104) included in the retrieved electronic message, may be parsed. In general, the bank statement is heterogeneous data that includes type of transactions, the individual with whom the transaction is done, debit amount, or credit amount, and the like. In an example, the transaction parser 204 is configured to parse the financial record of the first entity and categorize based on the name of individuals or business entities with whom the plurality of transactions are done. In another example, the transaction parser 204 may be configured to parse the financial record of the first entity 104 and categorize the parsed records based on a parameter defined by the lender 114. The parameter may include the name of business entities included in the electronic messages. The transaction parser 204 utilizes natural language processing techniques to locate key information in the financial record such as, date, description, credit amount or debit amount, and the like, and classify them into predefined categories. The parsed messages are stored in the memory 120. In an embodiment, the parsed messages are categorized based on the name of individuals or business entities and are bucketed in the first memory element 212. The parsed messages categorized based on any criteria other than the name of individuals or the business entities are bucketed in the second memory element 214. The parsed messages are fed to the entities resolver 206.

The entities resolver 206 may be configured to process the parsed messages to identify records in the parsed messages that refer to same or equivalent entity. Thus, in the entities resolver 206, the records of the parsed messages that are nearly identical, but may not be exactly same, and refer to the same entity are identified and linked. Accordingly, the entities resolver 206 is configured to resolve the name of at least one of the individuals, the business entities, and enterprises in the parsed messages even if represented in different forms, formats, abbreviations, misspellings, or typographical errors to obtain a clean data.

In an example, an enterprise (for example, the second entity 106) may have conducted business transactions at different times with different business entities mentioned in the parsed messages with different names. In such a scenario, the entities resolver 206 is configured to compare various records of the parsed messages to decide that the same second entity 106 has conducted transactions with multiple or different business entities available in the parsed message. In another example, the second entity 106 may have conducted a transaction with the first entity 104 by name Kart.LLC. Further, the second entity 106 may have conducted another transaction with another entity by name Kart.PVT LTD. In reality, Kart.LLC and Kart. PVT LTD refer to the same entity. The entities resolver 206 is configured to identify and inform that Kart.LLC and Kart. PVT LTD refer to the same entity.

The processing circuitry 122 is further configured to implement the crawler system 208 to retrieve a set of details regarding the identified entity or unique entity identified by the entities resolver 206 (for example, the second entity 106 as illustrated above). The crawler system 208 implements a set of crawlers configured to find and ingest data from one or more resources and store the acquired data in the memory 120. In an embodiment the acquired data is stored in the third memory element 216. The one or more resources may include internal resources or external resources. The internal resources may include internal database, legacy systems, or repositories maintained by the lender 114. The external resources may include collecting data from web resources (such as web pages). In an example, the web resources may be Google®, Indiamart®, webpage of the identified entity (such as second entity 106) or the like.

The acquired data may be collected from one or more resources by batch ingestion or stream ingestion. In an embodiment, in batch ingestion, data is moved from the one or more resources to the memory 120 in batches at regular times. A scheduler, trigger event, or logical ordering may be used to gather data at the regular times. In an example, batch ingestion may be used for souring the historical data record. In another embodiment, data may be collected from the one or more resources and stored in the memory 120 in real time. The data may be sourced as soon as the data is acquired. Stream ingestion may be used when data is continually sourced, refreshed, or updated. In an example, the stream ingestion may be used for sourcing the new electronic message.

The set of details may include personal information or public information associated with the second entity 106. In an embodiment, the personal information may include the financial records of the second entity 106 and are often accessed using the internal resources maintained by the lender 114. For example, the financial records of the second entity 106 may be collected from the internal resources maintained by the lender 114. In an embodiment, if the second entity 106 had ever visited the lender 114 and submitted the second loan application, the financial records of the second entity 106 may be available and can be collected by the internal resources. In another embodiment, if the second entity 106 never visited the lender 114 or submitted a loan application, the financial records of the second entity 106 may not be available in the internal resources. The public information may include may include name of business owner, type of business, business registration proof, business address, Goods and Service Tax (GST) number, Permanent Account Number (PAN) number, number of employees, age of the business, and the like. The public information is often accessed using the external resources. Subsequently, the set of details obtained from the internal resources and/or external resources are normalized.

The graph generator 210 generates the knowledge graph by ingesting, processing, and transforming the data from the entity resolver 206 and the crawler system 208. The data collected by the entity resolver 206 and the crawler system 208 are extracted. A comprehension engine, using semantic computing techniques, observes and infers primary, secondary, and tertiary relationships and attributes of the extracted data and the knowledge graph is generated. The knowledge graph is presented to the lender 114 via the lender device 112 for advance insights such as identification of the potential borrower and assessment of credit risk associated with the identified potential borrower. In an embodiment, the knowledge graph may be continuously enriched based on the new information received from the entity resolver 206 and/or the crawler system 208.

A credit risk assessment analysis is performed by the processing circuitry 122 may be used to generate a credit risk score. Firstly, an insight from the knowledge graph is derived to identify a business entity from the various business entities (nodes) represented in the knowledge graph that may be looking for funds. Subsequently, the credit risk assessment of the identified entity (depicted as a node in the knowledge graph) is done. Machine learning algorithms assist in the credit risk assessment by analyzing the financial record of the identified entity. The relations between the nodes are represented by edges. In an example, each node of the nodes represents a business entity. The business entities between which one or more business transactions have been carried out are related by the edges. In an embodiment, the machine learning algorithms may assign a credit risk score based on the credit risk assessment. The credit risk score may be a numerical score. In another embodiment, if the credit risk score of the identified entity is greater than a threshold value, it is predicted that the identified entity is likely to default loan repayment or go delinquent. In an embodiment, if the credit risk score of the identified entity is less than the threshold value, it is predicted that the identified entity is unlikely to default loan repayment. The threshold value may be set or decided by the lender 114.

The credit risk assessment may also be represented on a scale. When the credit risk score of the identified entity is less than a first predefined value, the identified entity is less likely to default and associated risk is low. When the credit risk score of the identified entity is greater than the first predefined value but less than a second predefined value, the identified entity may default and associated risk is medium. When the credit risk score of the identified entity is more than the second predefined value, the identified entity is highly likely to default and associated risk is high. In an embodiment, the first predefined value and the second predefined value are customizable by the lender 114.

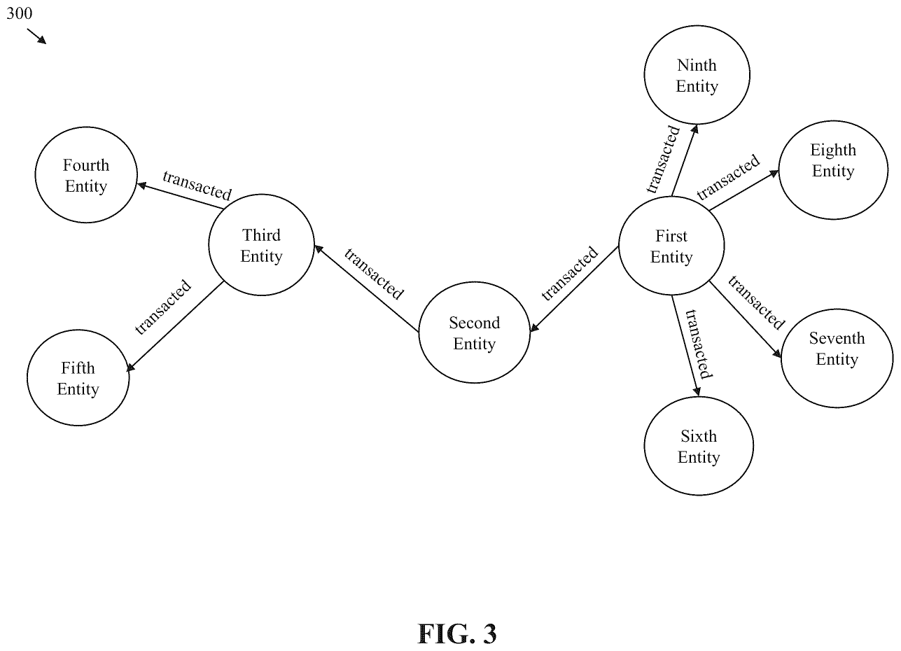

FIG. 3 is an example of knowledge map 300, in accordance with an embodiment of the present disclosure. Elements in the knowledge graph are represented by circular shapes called nodes, and the relationships between the nodes are represented by lines called edges. The nodes represent entities, and the edges represent relationships between the entities. The edges have a direction and relation indictor such as “transacted”. The direction depicts a flow of relationship between connected nodes. In an embodiment, the relation indicator may be any other value, such as, amount of transaction, credit, debit, or the like. The nodes or set of nodes are used as one parameter and edges or the set of edges are used as another parameter. In an example, the knowledge map 300 has nine nodes depicting first entity to ninth entity and edges depicts business transactions conducted between the nodes. As shown, the first entity has transacted with the second entity and the second entity has transacted with a third entity. Further, the third entity has transacted with a fourth entity and a fifth entity and so on and so forth. In an embodiment, each node of the set of nodes may be assigned a credit risk score indicating a probability of the node to default loan repayment. Thus, the knowledge graph assists the lender 114 to predict potential borrows and associated credit risk.

In general, traditionally known data such as potential borrower's online activities, browsing history, interactions with one or more financial contents, and the like are used for identification of the potential borrower. However, the traditionally known data are often inaccurate and include noise, leading to an inaccurate identification of potential borrowers. Additionally, the traditionally known data are insufficient for assessment of credit risk and prediction of credit risk score of the potential borrower. Therefore, in order to enhance the accuracy of identification of the potential borrower and prediction of associated credit risk, it is pertinent to process a refined, structured, and reliable data as an input. Accordingly, when the identification of the potential borrower and the prediction of associated risk is obtained based on the input data such as the financial records that depicts cash flow, details of transactions conducted by the potential borrower, and industry related information of the potential borrower the assessment of credit risk associated with the potential borrower is precise and reliable. Hence, the potential borrower is identified based on the precise and reliable credit risk assessment results in identification of the borrowers who are less like to default the loan repayment.

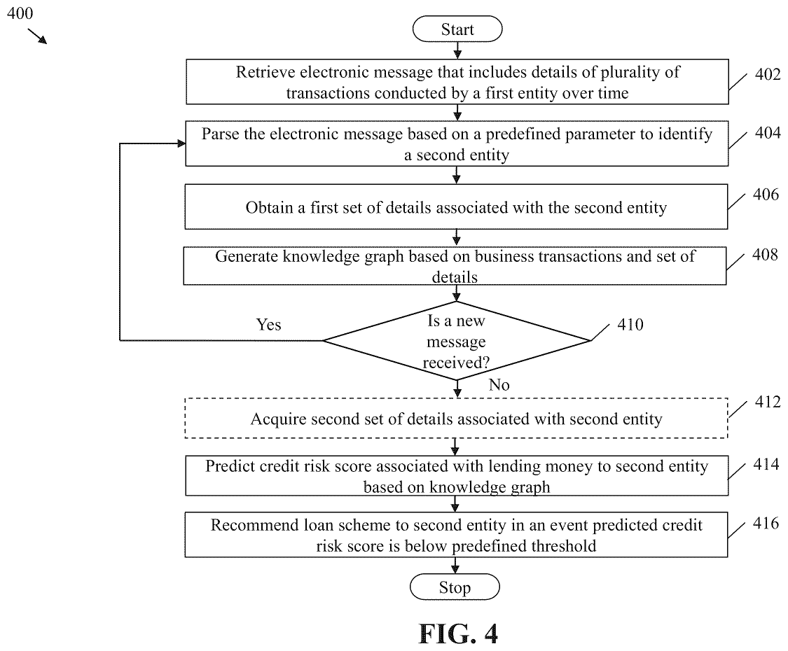

FIG. 4 represents a flowchart 400 that illustrates a method for a borrower identification and prediction of credit risk associated with the identified borrower, in accordance with an embodiment of the present disclosure.

At step 402, the server 102 retrieves an electronic message that includes details of a plurality of transactions conducted by the first entity 104 over a time. The electronic message may include the profile and the financial record of the first entity 104. The electronic message may be received in a format such as pdfs, word, or excel.

At step 404, the server 102 parses the electronic message based on a predefined parameter, to identify a second entity 106 in the electronic message. The second entity 106 is an entity with which the first entity 104 has conducted a business transaction. The second entity 106 is a potential individual seeking a loan. Parsing the electronic message may include breaking the electronic message into small elements to identify one or more business entities involved in one or more of the plurality of transactions. The predefined parameter includes name of one or more business entities included in the electronic message.

At step 406, the server 102 obtains a first set of details associated with the second entity 106 from one or more resources associated with the server 102. The first set of details corresponds to personal information associated with the second entity 106, where the personal information may include financial record of the second entity 106. The one or more resources may include an internal resource maintained by a lender 114 or an external resource available on internet.

At step 408, the server 102 generates a knowledge graph based on the business transaction and the first set of details. The knowledge graph indicates an association between the first entity 104 and the second entity 106.

At step 410, the server 102 determines if a new electronic message has been received. The new electronic message may include the profile and the financial record of the new entity. In case new electronic message has been received, the method repeats from step 404. In case new electronic message has been received, the method moves to step 412.

At step 412, the server 102 acquires a second set of details corresponding to the second entity 106 from the one or more resources. The second set of details corresponds to public information associated with the second entity 106.

At step 414, the server 102 predicts a credit risk score associated with lending money to the second entity 106 based on the knowledge graph. The server 102 compares the credit risk score with a predefined threshold value to identify if it would be safe to issue the loan to the second entity 106. In an embodiment, the predefined threshold value is set by the lender 114.

At step 416, the server 102 recommends a loan scheme to the second entity 106 in an event the predicted credit risk score is below a predefined threshold.

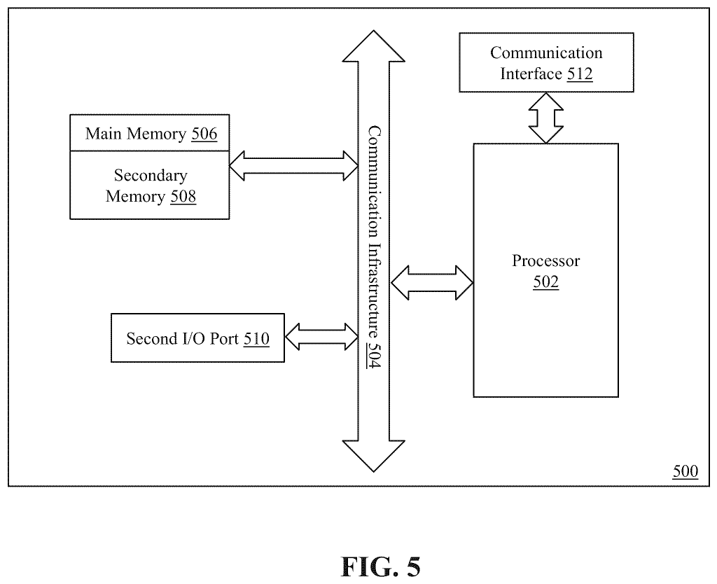

FIG. 5 is a block diagram that illustrates a system architecture of a computer system 500 for borrower identification, in accordance with an exemplary embodiment of the disclosure. An embodiment of the disclosure, or portions thereof, may be implemented as computer-readable code on the computer system 500. In one example, the system 100 of FIG. 1 may be implemented in the computer system 500 using hardware, software, firmware, a non-transitory computer-readable medium having instructions stored thereon, or a combination thereof, and may be implemented in one or more computer systems or other processing systems. Hardware, software, or any combination thereof may embody modules and components used to implement the method of FIG. 4.

The computer system 500 may include a processor 502 that may be a special-purpose or a general-purpose processing device. The processor 502 may be a single processor or multiple processors. The processor 502 may have one or more processor “cores.” Further, the processor 502 may be coupled to a communication infrastructure 504, such as a bus, a bridge, a message queue, the communication network 126, a multi-core message-passing scheme, or the like. The computer system 500 may further include a main memory 506 and a secondary memory 508. Examples of the main memory 506 may include RAM, ROM, and the like. The secondary memory 508 may include a hard disk drive or a removable storage drive (not shown), such as a floppy disk drive, a magnetic tape drive, a compact disc, an optical disk drive, a flash memory, or the like. Further, the removable storage drive may read from and/or write to a removable storage device in a manner known in the art. In an embodiment, the removable storage unit may be a non-transitory computer-readable recording medium.

The computer system 500 may further include a second input/output (I/O) port 510 and a communication interface 512. The second I/O port 510 may include various input and output devices that are configured to communicate with the processor 502. Examples of the input devices may include a keyboard, a mouse, a joystick, a touchscreen, a microphone, and the like. Examples of the output devices may include a display screen, a speaker, headphones, and the like. The communication interface 512 may be configured to allow data to be transferred between the computer system 500 and various devices that are communicatively coupled to the computer system 500. Examples of the communication interface 512 may include a modem, a network interface, i.e., an Ethernet card, a communication port, and the like. Data transferred via the communication interface 512 may be signals, such as electronic, electromagnetic, optical, or other signals as will be apparent to a person skilled in the art. The signals may travel via a communications channel, such as the communication network 126, which may be configured to transmit the signals to the various devices that are communicatively coupled to the computer system 500. Examples of the communication channel may include wired, wireless, and/or optical media such as cable, fiber optics, a phone line, a cellular phone link, a radio frequency link, and the like. The main memory 506 and the secondary memory 608 may refer to non-transitory computer-readable mediums that may provide data that enables the computer system 500 to implement the methods illustrated in FIG. 4.

A person of ordinary skill in the art will appreciate that embodiments and exemplary scenarios of the disclosed subject matter may be practiced with various computer system configurations, including multi-core multiprocessor systems, minicomputers, mainframe computers, computers linked or clustered with distributed functions, as well as pervasive or miniature computers that may be embedded into virtually any device. Further, the operations may be described as a sequential process, however, some of the operations may in fact be performed in parallel, concurrently, and/or in a distributed environment, and with program code stored locally or remotely for access by single or multiprocessor machines. In addition, in some embodiments, the order of operations may be rearranged without departing from the spirit of the disclosed subject matter.

Techniques consistent with the disclosure provide, among other features, systems, and methods for a borrower identification and prediction of credit risk associated with the identified borrower. While various exemplary embodiments of the disclosed systems and methods have been described above, it should be understood that they have been presented for purposes of example only, and not limitations. It is not exhaustive and does not limit the disclosure to the precise form disclosed. Modifications and variations are possible in light of the above teachings or may be acquired from practicing of the disclosure, without departing from the breadth or scope.

While various embodiments of the disclosure have been illustrated and described, it will be clear that the disclosure is not limited to these embodiments only. Numerous modifications, changes, variations, substitutions, and equivalents will be apparent to those skilled in the art, without departing from the spirit and scope of the disclosure, as described in the claims.

What is claimed is:

1. A method comprising:
retrieving, by a server, an electronic message that includes details of a plurality of transactions conducted by a first entity over a time;
parsing, by the server, the electronic message based on a predefined parameter, to identify a second entity, wherein the first entity has conducted a business transaction, of the plurality of transactions, with the second entity;
obtaining, by the server, a first set of details associated with the second entity from one or more resources associated with the server;
generating, by the server, a knowledge graph based on the business transaction and the first set of details, wherein the knowledge graph indicates an association between the first entity and the second entity; and
predicting, by the server, a credit risk score associated with lending money to the second entity based on the knowledge graph.

2. The method as claimed in claim 1, further comprising acquiring, by the server, a second set of details associated with the second entity from the one or more resources.

3. The method as claimed in claim 2, wherein the second set of details corresponds to public information associated with the second entity.

4. The method as claimed in claim 1, wherein the first set of details corresponds to personal information associated with the second entity, wherein the personal information includes financial record of the second entity.

5. The method as claimed in claim 1, wherein the one or more resources includes an internal resource maintained by a lender or an external resource available on internet.

6. The method as claimed in claim 1, further comprising recommending a loan scheme to the second entity in an event the predicted credit risk score is below a predefined threshold.

7. The method as claimed in claim 1, further comprising receiving, by the server, a new electronic message and updating the knowledge graph with a new business entity included in the new electronic message.

8. The method as claimed in claim 1, wherein the second entity is a potential individual seeking a loan.

9. The method as claimed in claim 1, wherein the electronic message is received in a format such as pdfs, word, or excel.

10. The method as claimed in claim 1, wherein parsing the electronic message includes breaking the electronic message into small elements to identify one or more business entities involved in one or more of the plurality of transactions.

11. The method as claimed in claim 1, wherein the predefined parameter includes name of one or more business entities included in the electronic message.

12. A system, comprising:
a server configured to:
retrieve an electronic message that includes details of a plurality of transactions conducted by a first entity over a time;
parse the electronic message based on a predefined parameter, to identify a second entity, wherein the first entity has conducted a business transaction, of the plurality of transactions, with the second entity;
obtain a first set of details associated with the second entity from one or more resources associated with the server;
generate a knowledge graph based on the business transaction and the first set of details, wherein the knowledge graph indicates an association between the first entity and the second entity; and
predict a credit risk score associated with lending money to the second entity based on the knowledge graph.

13. The system as claimed in claim 12, wherein the server is further configured to acquire a second set of details associated with the second entity from the one or more resources.

14. The system as claimed in claim 13, wherein the second set of details corresponds to public information associated with the second entity.

15. The system as claimed in claim 12, wherein the first set of details corresponds to personal information associated with the second entity, wherein the personal information includes financial record of the second entity.

16. The system as claimed in claim 12, wherein the one or more resources includes an internal resource maintained by a lender or an external resource available on internet.

17. The system as claimed in claim 12, wherein the server is further configured to recommend a loan scheme to the second entity in an event the predicted credit risk score is below a predefined threshold.

18. The system as claimed in claim 12, wherein the server is further configured to receive a new electronic message and update the knowledge graph with a new business entity included in the new electronic message.

19. The system as claimed in claim 12, wherein the second entity is a potential individual seeking a loan.

20. A non-transitory computer-readable medium, having stored thereon, computer-executable instructions that, when executed by a computer, cause the computer to execute operations, the operations comprising:
retrieving, by a server, an electronic message that includes details of a plurality of transactions conducted by a first entity over a time;
parsing, by the server, the electronic message based on a predefined parameter, to identify a second entity, wherein the first entity has conducted a business transaction, of the plurality of transactions, with the second entity;
obtaining, by the server, a first set of details associated with the second entity from one or more resources associated with the server;
generating, by the server, a knowledge graph based on the business transaction and the first set of details, wherein the knowledge graph indicates an association between the first entity and the second entity; and
predicting, by the server, a credit risk score associated with lending money to the second entity based on the knowledge graph.
